(19) United States
(12) Patent Application Publication
(10) Pub. No.: US 2004/0025131 A1
(43) Pub. Date: Feb. 5, 2004

(54) Method and apparatus for placing repeater banks in integrated circuit design

(75) Inventors: Sunil K. Walia, Sunnyvale, CA (US); James Y. Ho, Sunnyvale, CA (US); Harpreet S. Anand, Fremont, CA (US); Yoganand Chillarige, Sunnyvale, CA (US)

Correspondence Address: David B. Ritchie, Thelen Reid & Priest LLP, P.O. Box 640640, San Jose, CA, 95164-0640, US

(73) Assignee: Sun Microsystems, Inc., a Delware Corporation

(21) Appl. No.: 10/213,657

(22) Filed: Aug. 5, 2002

(51) Int. Cl. G06F 17/50

(52) U.S. Cl. 716/10; 716/7

(57) ABSTRACT

A method for placing repeater banks in an integrated circuit (IC) design, the IC design including a plurality of circuit blocks placed in an IC design area, the method includes (a) obtaining information of virtual coordinates of virtual repeaters, the virtual repeaters being inserted individually in signal paths between the circuit blocks, the virtual coordinates representing physical location of each of the virtual repeaters in the IC design area, (b) dividing the IC design area into a plurality of sections, (c) determining, for each of the sections, a quantity of the virtual repeaters having the virtual coordinates within the section, (d) clustering, for each of the sections, the virtual repeaters into a repeater bank having a selected size in accordance with the quantity of the virtual repeaters in the section, and (e) assigning to each of the repeater banks a location to be placed within the corresponding section.

### FIELD OF THE INVENTION

The present invention relates to integrated circuit (IC) designs. More particularly, the present invention relates to a method and apparatus for placing repeater banks in an IC design.

### BACKGROUND OF THE INVENTION

A typical IC design flow includes conceptual design process and design implementation process which includes logical implementation and physical implementation. In a conceptual design process, a design concept is translated into a functional design description, typically in a hardware description language (HDL). An electronic circuit can be described in several levels, including the Register-Transfer-Level (RTL), the gate level, and the transistor level. A HDL is used to define the functions of an electronic circuit for documentation, simulation, and/or logic synthesis. Through the logical implementation process, the HDL description is converted into a list of electronic devices such as logic gates, transistors and other circuit elements, and the interconnections thereof. Such a list is typically referred to as a netlist. The physical implementation process includes, for example, relative placement of the electronic devices and connections, definition of geometrical patterns for the electronic devices, circuit blocks, and/or circuit cores, layout of those geometrical patterns on an IC chip area, and providing interconnections for fabrication. Various Electronic Design Automation (EDA) tools are used for both conceptual design and design implementation processes.

FIG. 1 schematically and conceptually illustrates circuit blocks 12 and signal paths 10 between the circuit blocks 12 in an IC design. When a signal path is provided from one circuit block to another, repeaters (buffers) 14 are inserted along the signal path. The repeaters 14 are required to preserve the waveform (a specified slew-rate) of the signal and to ensure a proper operation of the devices in the destination circuit block. The repeaters also reduce the RC delay of the signal path. Typically, an EDA tool such as a repeater insertion software tool is used for such repeater insertions during an implementation process. For example, repeaters are inserted based on signal routing topology, a set of parameters such as width, length, spacing of the wire (metal layer) for the signal path, a required slew-rate of the signal, and the like. Repeaters are typically buffers (or chain of inverters) as is well known to one of ordinary skill in the art.

### BRIEF DESCRIPTION OF THE INVENTION

A method for placing repeater banks in an integrated circuit (IC) design, the IC design including a plurality of circuit blocks placed in an IC design area, the method includes (a) obtaining information of virtual coordinates of virtual repeaters, the virtual repeaters being inserted individually in signal paths between the circuit blocks, the virtual coordinates representing physical location of each of the virtual repeaters in the IC design area, (b) dividing the IC design area into a plurality of sections, (c) determining, for each of the sections, a quantity of the virtual repeaters having the virtual coordinates within the section, (d) clustering, for each of the sections, the virtual repeaters into a repeater bank having a selected size in accordance with the quantity of the virtual repeaters in the section, and (e) assigning to each of the repeater banks a location to be placed within the corresponding section.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a diagram schematically and conceptually illustrating circuit blocks and signal paths between the circuit blocks in an IC design.

FIG. 2 is a diagram schematically illustrating an example of a layout of circuit blocks in an IC design.

FIG. 3 is a process flow diagram schematically illustrating a method for placing repeater banks in an IC design in accordance with one embodiment of the present invention.

FIG. 4 is a diagram illustrating an example of repeater bank selection in accordance with one embodiment of the present invention.

FIG. 5A is a diagram schematically illustrating an IC area divided into sections in accordance with one embodiment of the present invention.

FIG. 5B is a diagram schematically illustrating repeater banks placed in sections of the IC design area in accordance with one embodiment of the present invention.

FIG. 6 is a diagram illustrating an example of an IC design area (IC chip) in which circuit blocks and cores are placed (top-level block layout).

FIG. 7 is a diagram illustrating an example of repeater banks placed in the IC design area in accordance with one embodiment of the present invention.

FIG. 8 is a diagram illustrating a view of the repeater banks overlaid on the toplevel block layout in the IC design area in accordance with one embodiment of the present invention.

FIG. 9 is a diagram illustrating an example of utilization of repeater banks in accordance with one embodiment of the present invention.

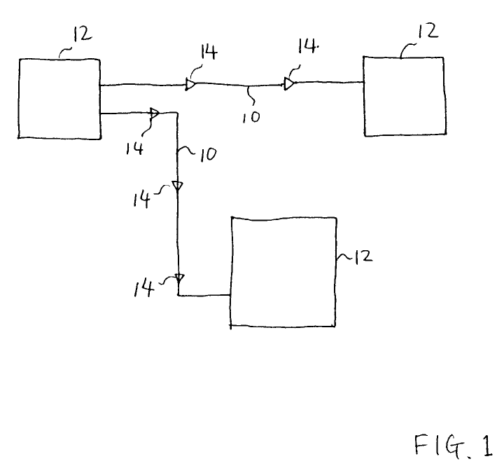

### DETAILED DESCRIPTION

Embodiments of the present invention are described herein in the context of a method and apparatus for placing repeater banks in an integrated circuit (IC) design. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, or a stand-alone device. The process can be implemented as instructions executed by such hardware, hardware alone, or any combination thereof. The software may be stored on a program storage device readable by a machine.

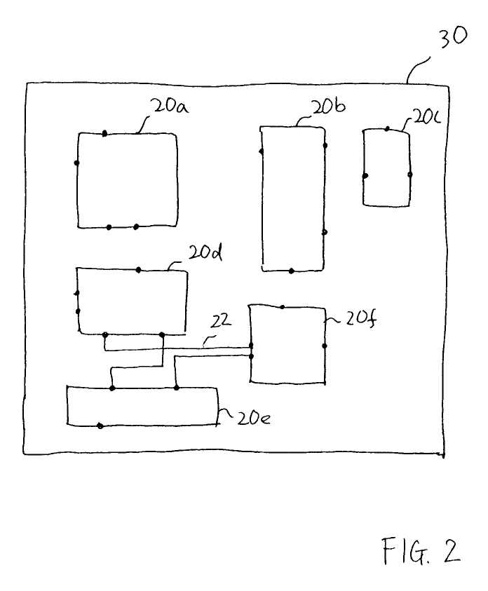

FIG. 2 schematically illustrates an example of a layout of circuit blocks 20 (20a, 20b, 20c, . . . ) of an IC design. The circuit blocks 20 are placed in an IC design area 30, typically an area of an IC chip. FIG. 2 also shows some of the signal paths (pin-to-pin connections) 22 provided between the circuit blocks 20. Typically, in an IC design flow, circuit block placement, pin assignment, routing, and timing processes are performed before the repeater insertion. The information of such pre-repeater insertion processes may be stored in several files. For example, a design file contains geometric information on the circuit block placement, and a session file contains routing information. Timing model may be stored as a pearl file, and connectivity information (typically pin-to-pin connections) is contained in a register-transfer level (RTL) code file.

In the repeater insertion process using a repeater insertion tool, each signal path is analyzed separately and individual repeaters are automatically placed on the signal paths. The repeaters may be placed on each net based on the route topology, wire-classes, slow mode criteria, and the like. Since these repeaters are automatically inserted in the net based on given IC design information, and thus they are not the actual or physical repeaters to be formed on an IC chip, they are referred to as “virtual” repeaters. This approach is extended to cluster repeaters within a certain sectional area of the chip, and a bank of repeaters is placed at the center of the section. However, prior to the present invention, this process was manually conducted, and physical repeater banks were manually scattered across the chip randomly. Such a manual process caused poor utilization of repeater banks, poor area usage, and increased leakage power, yet it did not provide a 100% solution to all the nets. It was an extensively interactive process to reach a 100% solution, and to improve utilization was also time-consuming.

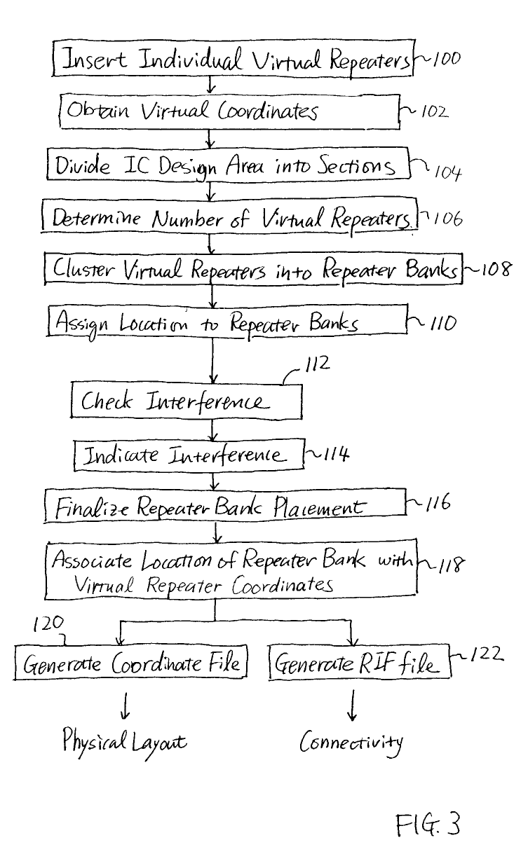

FIG. 3 schematically illustrates a method for placing repeater banks in an IC design in accordance with one embodiment of the present invention. Prior to placing repeater banks, individual repeaters are inserted in each signal path using a repeater insertion tool (100), as described above. The repeater insertion tool uses information on a given IC design, such as circuit block placement, routing, timing, and connectivity, and inserts individual repeaters between circuit blocks as necessary to maintain specified signal conditions on the paths. The repeater insertion tool may use various files as described above.

After insertion of virtual repeaters, the virtual coordinate information is obtained (102). The virtual coordinates represent the intended physical location of each of the virtual repeaters in the IC design area. In addition to the virtual coordinates, the instance names of the virtual repeaters may be used. For example, a typical file generated by a repeater insertion tool contains the x- and y- coordinates of the virtual repeaters and their instance names and another file which generates the new connection information with virtual repeaters added. A set of coordinates (x, y) represents a precise physical location on the IC design area. Then, the IC design area is divided into a plurality of sections (or sectors) (104). Each of the sections can be specified by the coordinates of the IC design area. The quantity (or number) of the virtual repeaters within each section is then determined based on the virtual coordinates (106). For example, the virtual repeaters having the virtual coordinates that fall within the range of a specific section can be counted to obtain the quantity.

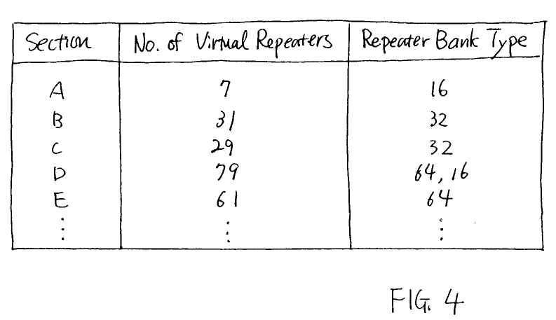

A repeater bank is selected for each section in accordance with the quantity of the virtual repeaters within that section. That is, for each section, the virtual repeaters are clustered into a repeater bank (108). The repeater bank may have a best-fit size selected from a set of available sizes such as 16, 32, and 64. Here, “size n” means that the repeater bank includes n number of repeaters (buffers) or “slots.” FIG. 4 illustrates an example of repeater bank selection. As shown in FIG. 4, the repeater bank size 16 is selected for sections having up to 16 virtual repeaters, and the repeater bank size 32 is selected for sections having up to 32 virtual repeaters, and the like.

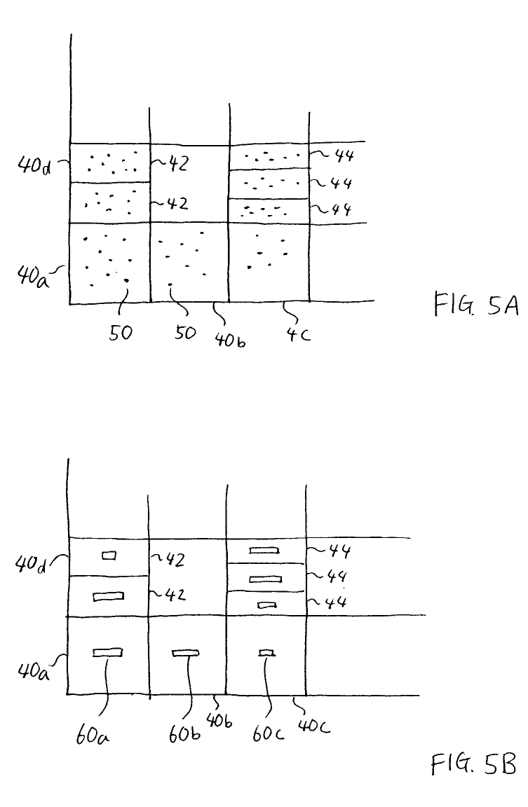

Referring back to FIG. 3, each of the repeater banks is then assigned with a location to be placed within the corresponding section (110). Typically, each repeater bank is placed in the center of the section. FIG. 5A schematically illustrates sections 40 (40a, 40b, . . . ) of an IC design area and the virtual repeaters 50 plotted thereon according to the virtual coordinates. FIG. 5B schematically illustrates the corresponding repeater banks 60 (60a, 60b, . . . ) into which the virtual repeaters 50 are clustered. The repeater bank location may be determined based on the physical size of the repeater bank, the clustering algorithm, and the like. It should be noted that circuit blocks of the IC design are not shown in FIGS. 5A and 5B.

In the case where the quantity of the virtual repeaters of a section (for example, section D in FIG. 4) exceeds the maximum available size (for example, 64), one or more additional repeater banks may be selected. For example, a combination of the available sizes may be selected so as to accommodate the total number of virtual repeaters in that section. In accordance with one embodiment of the present invention, if the quantity of the virtual repeaters in a section exceeds the maximum available repeater bank size, the section is sub-divided into sub-sections. For example, as shown in FIG. 5A, the section 40d may be divided into two sub-sections 42. For each of the subsections 42, the virtual repeaters are clustered into a repeater bank in accordance with the quantity of the virtual repeaters in the sub-section in the same manner as that for the sections. Depending on the total virtual repeater quantity of the section, one section can be divided into 3 sub-sections 44 (or more). These sub-sections are typically equal in size.

However, two or more vertically adjacent sub-sections can be combined to optimize utilization of the repeater bank. For example, a sub-section has nine (9) virtual repeaters therein and the sub-section immediately below the subsection has four (4) virtual repeaters, then the two sub-sections and are combined and a repeater bank size of 16 is selected for the re-combined section. This sub-section recombination algorithm optimizes utilization because without the recombination, two repeater banks of size 16 would be used to accommodate the 9 and 4 virtual repeaters. Similarly, if the next subsection has 18 virtual repeaters, the optimization algorithm may further combine the third sub-section so as to select one repeater bank of size 32 for these three sub-sections.

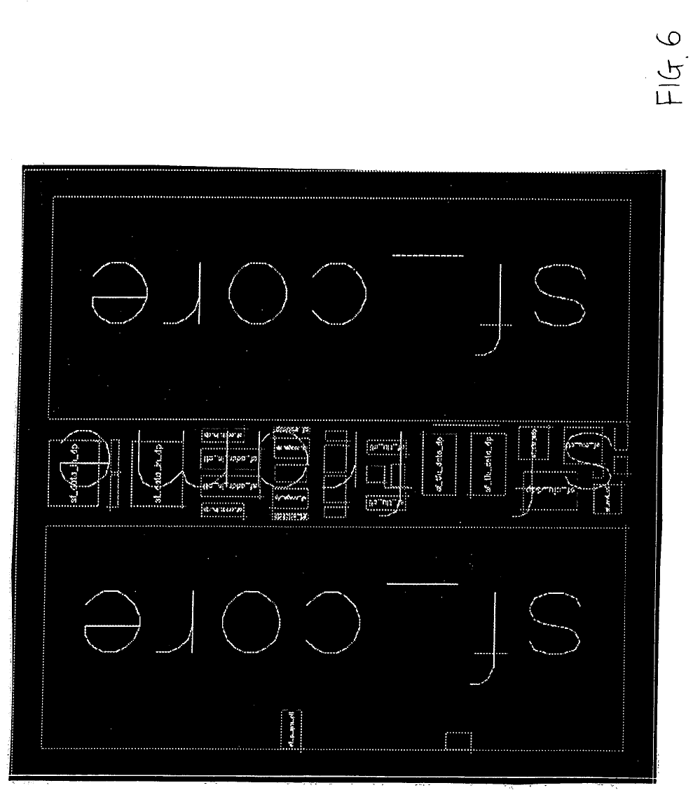

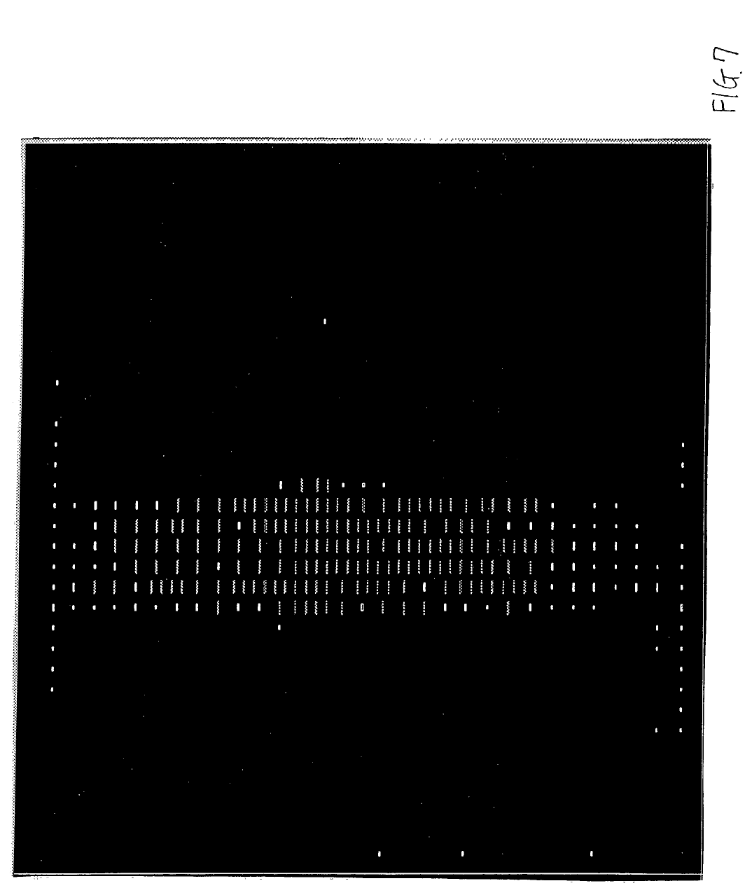

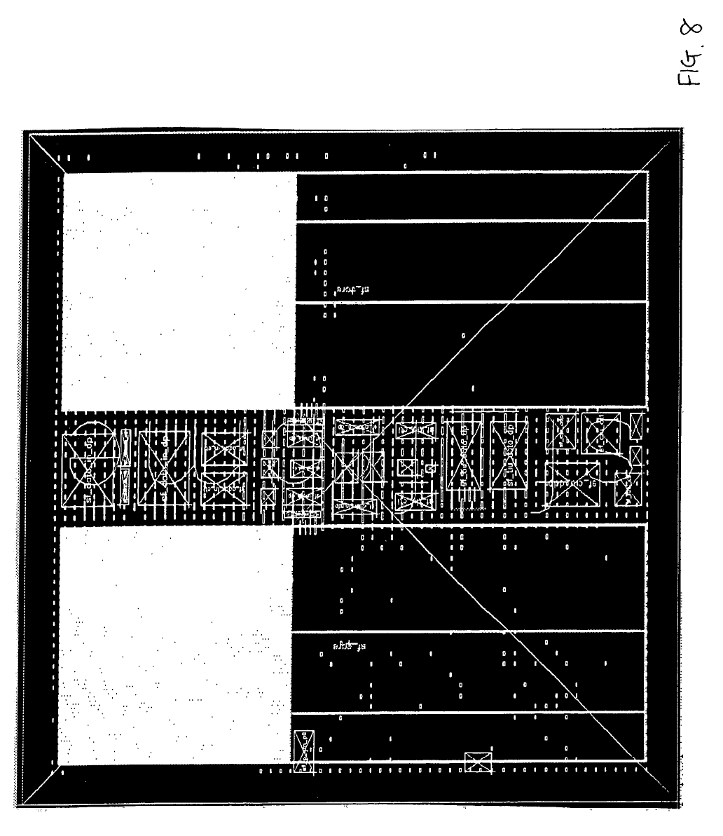

FIG. 6 illustrates an exemplary view of an IC design area (IC chip) in which circuit blocks and cores are placed (top-level block layout). FIG. 7 illustrates an example of repeater banks placed in the IC design area using the above-mentioned processes. Such a view of the repeater banks may be produced using a computer aided design (CAD) tool such as Opus, available from Cadence Design Systems of San Jose, Calif., which reads the repeater bank coordinates and places their abstract/layout view in a separate cell. Since the repeater banks are selected based on the quantity of the virtual repeaters in the section and placed in the center of each section (or sub-section), the location of the repeater banks may interfere with existing circuit blocks. FIG. 8 illustrates the view of the repeater banks overlaid on the top-level block layout in IC design area. As shown in FIG. 8, some of the repeater banks are overlapped with circuit blocks.

In accordance with one embodiment of the present invention, referring back to FIG. 3, the repeater bank placement is checked against the existing circuit blocks in the IC design area (112) and interference conditions are indicated (114). For example, a list of the bounding coordinates for each circuit block is generated using the information of circuit block size, placement, and orientation. A circuit bock definition file containing circuit block size information, and a circuit block image file containing circuit block placement and orientation information may be used for extracting the bounding coordinates of the circuit blocks. Based on these coordinates, intersections of the repeater banks with the top-level circuit blocks can be determined. The interfering repeater banks are indicated, for example, by flagging such repeater banks. In addition, the extent of the intersection between the interfering repeater bank and the circuit block may be determined, and the possible rectification (solution) by movement of the repeater bank may also be analyzed and reported.

In one exemplary IC design, 11,602 virtual repeaters are provided in the total number of 968 sections with the section size of 1 mm×1 mm. By clustering the virtual repeaters into repeater banks, 364 repeater banks are placed without conflicts, and 602 repeater banks are found interfering with circuit blocks. It should be noted, however, that these quantities are presented for illustrative purpose only, and are not intended to be exhaustive or limiting in any way. In addition, the variables such as the section size and the repeater bank size are programmable, and such programmability provides more flexibility for designs to obtain an optimum result. For example, a set of available bank sizes and possible combinations thereof may be specified. The section size may also be specified by an input parameter, or the section size may vary depending on virtual repeater density. The manner of sub-division, for example, the maximum number of subsections within one section and/or the direction of sub-division is calculated based on defined parameters, such as maximum repeater bank length, repeater width, minimum required vertical and horizontal gaps between repeater banks and section size.

Furthermore, a threshold virtual repeater quantity may be set to place a repeater bank in a given section. For example, when the quantity of the virtual repeaters is less than the threshold value, for example 5, it would be efficient to provide individual repeaters in the section than placing a repeater bank of size 16.

The interfering repeater banks are manually relocated based on the indication, or may be relocated using program translation of the repeater banks. After finalizing the repeater bank placement (116), the location of each repeater bank is associated with the virtual coordinates of the virtual repeaters of the section (118). This association maintains the connectivity of each of the virtual repeaters. For example, such connectivity information is available from a repeater insertion format (RIF) file of the repeater insertion tool. The connectivity of each virtual repeater is correlated to a position on the intended repeater bank. That is, the connectivity of the virtual repeaters is translated into the connectivity of the repeater banks. For example, an output file may include a list that associates instance names of the virtual repeaters to the instant name and element (slot) within the placed repeater banks. By defining the connectivity of each of the repeater banks, the need to re-run the repeater insertion tool to connect up the repeater banks is eliminated.

Based on the clustering of virtual repeaters in each section, a repeater bank coordinate file is generated (120) so as to produce a physical layout of the repeater banks in the IC design area. The file may be in an Opus format which is output to a screen. A new repeater insertion format (RIF) file for the repeater banks is also generated (122) to produce a register transfer level (RTL) code file reflecting the repeater bank connectivity. In addition, summary and/or detail information on the repeater bank replacement may be generated. For example, sections of the IC design area may be classified into (1) sections with a single repeater bank (“placed” sections), (2) sections with multiple repeater banks (“multi-bank” sections), and (3) sections without repeater banks (“unplaced” sections) and reported to a file.

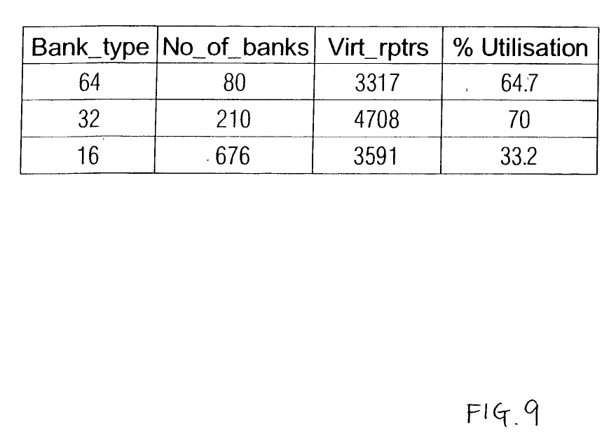

FIG. 9 illustrates an example of utilization of the repeater banks in accordance with one embodiment of the present invention. As described above, a best-fit repeater bank size is selected from the available repeater bank sizes for each section, increasing utilization of the repeater banks. For example, in the case of the above-mentioned IC design including about 11,600 virtual repeaters, eighty (80) repeater banks of size 64 are placed for 3,317 virtual repeaters, and the utilization of the type 64 repeater bank is about 65%. Similarly, 210 repeater banks of size 32 are used for about 4,700 virtual repeaters, yielding the utilization rate of 70%. As for the repeater banks of size 16, the utilization would be increased to about 70% by employing an “intelligent” placement such as introducing a threshold virtual repeater quantity per section, as described above.

The above-described repeater bank placement accounts for the virtual repeater density variations throughout the chip. This increases the repeater bank utilization and minimizes physical space and leakage power consumption, while preserving the existing signal route. The present invention provides a more intelligent method of placing repeater banks on the chip than the conventional manual placement, which is somewhat random in nature.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for placing repeater banks in an integrated circuit (IC) design, the IC design including a plurality of circuit blocks placed in an IC design area, said method comprising:
obtaining information of virtual coordinates of virtual repeaters, the virtual repeaters being inserted individually in signal paths between the circuit blocks, the virtual coordinates representing physical location of each of the virtual repeaters in the IC design area;
dividing the IC design area into a plurality of sections;
determining, for each of the sections, a quantity of the virtual repeaters having the virtual coordinates within the section;
clustering, for each of the sections, the virtual repeaters into a repeater bank having a selected size in accordance with the quantity of the virtual repeaters in the section; and
assigning to each of the repeater banks a location to be placed within the corresponding section.

2. The method in accordance with claim 1 wherein said clustering includes:
selecting a size of the repeater bank from a set of available repeater bank sizes.

3. The method in accordance with claim 2 wherein said clustering further includes:
adding a second repeater bank for the section if the quantity of the virtual repeaters in the section exceeds a maximum available repeater bank size.

4. The method in accordance with claim 2, further comprising:
sub-dividing the section into a maximum number of sub-sections if the quantity of the virtual repeaters in the section exceeds a maximum available repeater bank size; and
clustering, for each of the sub-sections, the virtual repeaters into a repeater bank having a selected size in accordance with the quantity of the virtual repeaters in the subsection; and
recombining adjacent subsections to improve utilization of the repeater banks.

5. The method in accordance with claim 1 wherein said clustering includes:
associating the location of the repeater bank of the section with the virtual coordinates of the virtual repeaters while maintaining connectivity of the virtual repeaters.

6. The method in accordance with claim 1, further comprising:
determining if the location of each of the repeater banks interfere with the circuit blocks placed in the IC design area; and
indicating the interfering repeater banks.

7. The method in accordance with claim 6, further comprising:
generating information of bounding coordinates for each of the circuit blocks for said determining.

8. The method in accordance with claim 6, wherein said determining includes:
determining an extent of intersection between the interfering repeater bank and the circuit block.

9. The method in accordance with claim 1, further comprising:
defining connectivity of the repeater banks to be placed in the IC design.

10. The method in accordance with claim 9, further comprising:
generating a repeater insertion format file for the repeater banks for producing a register transfer level code file reflecting the repeater bank connectivity.

11. The method in accordance with claim 1, further comprising:
generating a repeater bank coordinate file for producing a physical layout of the repeater banks in the IC design area.

12. An apparatus for placing repeater banks in an integrated circuit (IC) design, the IC design including a plurality of circuit blocks placed in an IC design area, said apparatus comprising:
means for obtaining information of virtual coordinates of virtual repeaters, the virtual repeaters being inserted individually in signal paths between the circuit blocks, the virtual coordinates representing physical location of each of the virtual repeaters in the IC design area;
means for dividing the IC design area into a plurality of sections;
means for determining, for each of the sections, a quantity of the virtual repeaters having the virtual coordinates within the section;
means for clustering, for each of the sections, the virtual repeaters into a repeater bank having a selected size in accordance with the quantity of the virtual repeaters in the section; and
means for assigning to each of the repeater banks a location to be placed within the corresponding section.

13. The apparatus in accordance with claim 12 wherein said means for clustering includes:
means for selecting a size of the repeater bank from a set of available repeater bank sizes.

14. The apparatus in accordance with claim 13 wherein said means for clustering further includes:
means for adding a second repeater bank for the section if the quantity of the virtual repeaters in the section exceeds a maximum available repeater bank size.

15. The apparatus in accordance with claim 14, further comprising:
means for sub-dividing the section into a maximum number of sub-sections if the quantity of the virtual repeaters in the section exceeds a maximum available repeater bank size; and
means for clustering, for each of the sub-sections, the virtual repeaters into a repeater bank having a selected size in accordance with the quantity of the virtual repeaters in the sub-section; and
means for recombining sub-sections to improve utilization of placed repeater banks.

16. The apparatus in accordance with claim 12 wherein said means for clustering includes:
means for associating the location of the repeater bank of the section with the virtual coordinates of the virtual repeaters while maintaining connectivity of the virtual repeaters.

17. The apparatus in accordance with claim 12, further comprising:
means for determining if the location of each of the repeater banks interfere with the circuit blocks placed in the IC design area; and
means for indicating the interfering repeater banks.

18. The apparatus in accordance with claim 17, further comprising:
means for generating information of bounding coordinates for each of the circuit blocks for said determining.

19. The apparatus in accordance with claim 17, wherein said means for determining includes:
means for determining an extent of intersection between the interfering repeater bank and the circuit block.

20. The apparatus in accordance with claim 12, further comprising:
means for defining connectivity of the repeater banks to be placed in the IC design.

21. The apparatus in accordance with claim 20, further comprising:
means for generating a repeater insertion format file for the repeater banks for producing a register transfer level code file reflecting the repeater bank connectivity.

22. The apparatus in accordance with claim 12, further comprising:
means for generating a repeater bank coordinate file for producing a physical layout of the repeater banks in the IC design area.

23. A program storage device readable by a machine, tangibly embodying a program of instructions executable by the machine to perform a method for placing repeater banks in an integrated circuit (IC) design, the IC design including a plurality of circuit blocks placed in an IC design area, said method comprising:
obtaining information of virtual coordinates of virtual repeaters, the virtual repeaters being inserted individually in signal paths between the circuit blocks, the virtual coordinates representing physical location of each of the virtual repeaters in the IC design area;
dividing the IC design area into a plurality of sections;
determining, for each of the sections, a quantity of the virtual repeaters having the virtual coordinates within the section;
clustering, for each of the sections, the virtual repeaters into a repeater bank having a selected size in accordance with the quantity of the virtual repeaters in the section; and
assigning to each of the repeater banks a position to be placed within the corresponding section.
